(19) United States
(12) Patent Application Publication
(10) Pub. No.: US 2008/0278846 A1
(43) Pub. Date: Nov. 13, 2008

(54) High friction rotating guide and magnetic tape system

(75) Inventors: James S. Anderson, Hugo, MN (US); Douglas W. Johnson, Stillwater, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/801,519

(22) Filed: May 10, 2007

(51) Int. Cl. G11B 5/105

(52) U.S. Cl. 360/85; 360/84

(57) ABSTRACT

A magnetic tape system comprises a magnetic tape, a magnetic head, a set of guides arranged to guide the magnetic tape along a tape path over the magnetic head, a first resistance mechanism, and a second resistance mechanism. The set of guides comprises a first rotatable guide positioned before the magnetic head along the tape path and including a first flyable tape path surface, and a second rotatable guide positioned after the magnetic head along the tape path and including a second flyable tape path surface. The first and second resistance mechanisms resist rotation of the first and seconds guides, respectively.

### TECHNICAL FIELD

The invention relates to magnetic tape used for data storage, and, more particularly, for magnetic tape guides used to guide the magnetic tape during media fabrication, servo recording, data recording, or data readout.

### BACKGROUND

Data storage media are commonly used for storage and retrieval of data, and come in many forms, such as magnetic tape, magnetic disks, optical tape, optical disks, holographic disks, cards or tape, and the like. Magnetic tape media remains an economical medium that is particularly useful in storing large amounts of data. For example, magnetic tape cartridges, or large spools of magnetic tape are commonly used to back up large amounts of data for computing centers or businesses. Magnetic tape cartridges also find application in the backup of data stored on smaller computers such as desktop or laptop computers.

In magnetic tape, data is typically stored as magnetic signals that are magnetically recorded on the medium surface. The data stored on the magnetic tape is often organized along “data tracks,” and read/write heads are positioned relative to the data tracks to write data to the tracks or read data from the tracks. Other types of data storage tape include optical tape, magneto-optic tape, holographic tape, and the like.

Magnetic tape systems typically include a set of guides arranged to guide the magnetic tape along a tape path over the magnetic head. The guides may be rotating or stationary guides. Rotating guides rotate as the tape passes over the guides, and stationary guides do not rotate as the tape passes over the guides. Additionally, the tape path surfaces of stationary guides (i.e., the surfaces over which the magnetic tape passes) may be flyable surfaces. As the tape moves across a stationary guide, the tape drags air with it and creates an air barrier between the guide and the magnetic tape. This air barrier lifts the magnetic tape off of the tape path surface of the guide and allows the magnetic tape to fly over the tape path surface. Rotating guides may include non-flyable surfaces that do not allow an air barrier sufficient to lift the magnetic tape off of the tape guide to form.

### SUMMARY

In general, the invention relates to a rotatable tape guide with a flyable surface. The tape guide rotates when there is high friction between a magnetic tape and the tape guide, but does not rotate when the magnetic tape is flying. A tape guide that rotates when there is high friction between the magnetic tape and the tape guide and does not rotate the tape guide when the magnetic tape is flying can help prevent the data storage tape from sticking to the tape guide and improve the ability to properly guide the data storage tape, e.g., during media fabrication, servo recording or readout, data recording, or data readout. The invention is useful for magnetic tape, but may also find application with optical tape, holographic tape, or other formats of data storage tape.

In one embodiment, the invention is directed to a magnetic tape system comprising a magnetic tape, a magnetic head, a set of guides arranged to guide the magnetic tape along a tape path over the magnetic head, the set of guides comprising a first rotatable guide positioned before the magnetic head along the tape path and including a first flyable tape path surface, and a second rotatable guide positioned after the magnetic head along the tape path and including a second flyable tape path surface, a first resistance mechanism that resists rotation of the first guide, and a second resistance mechanism that resists rotation of the second guide.

In another embodiment, the invention is directed to a set of guides arranged to guide a magnetic tape along a tape path over a magnetic head, the set of guides comprising a first rotatable guide positioned before the magnetic head along the tape path and including a first flyable tape path surface, and a second rotatable guide positioned after the magnetic head along the tape path and including a second flyable tape path surface, a first resistance mechanism that resists rotation of the first guide, and a second resistance mechanism that resists rotation of the second guide.

In another embodiment, the invention is directed to a rotatable tape guide assembly for data storage tape comprising a flyable tape path surface positioned along a tape path of a magnetic tape, an upper flange adjacent to the tape path surface, a lower flange adjacent to the tape path surface, and a resistance mechanism that resists rotation of the guide.

The invention may provide one or more advantages. For example, by rotating the guides when there is high friction between the magnetic tape and the guides, damage to the magnetic tape may be prevented. Additionally, by not rotating the guides when the tape is flying, the lateral tape motion may be reduced compared to guides that continue to rotate as the tape flies. Furthermore, in some embodiments, a brush may simultaneously help clean a tape guide of dirt and debris and provide resistance to rotation of the tape guide.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective view of a magnetic tape system including an arrangement of tape guides, a magnetic head, a magnetic tape passing through the guides and over the head, and a resistance mechanism that selectively inhibits rotation of the tape guides.

FIG. 2 is another perspective view of a magnetic tape to be passed over a tape guide.

FIG. 3 is a perspective view of an alternative magnetic tape system including an arrangement of tape guides, a magnetic head, a magnetic tape passing through the guides and over the head, and a resistance mechanism that selectively inhibits rotation of the tape guides.

FIG. 4 is another perspective view of a magnetic tape to be passed over an alternative tape guide.

FIG. 5 is a flowchart illustrating one embodiment of a method in which resistance is added to the rotation of a flyable tape guide.

### DETAILED DESCRIPTION

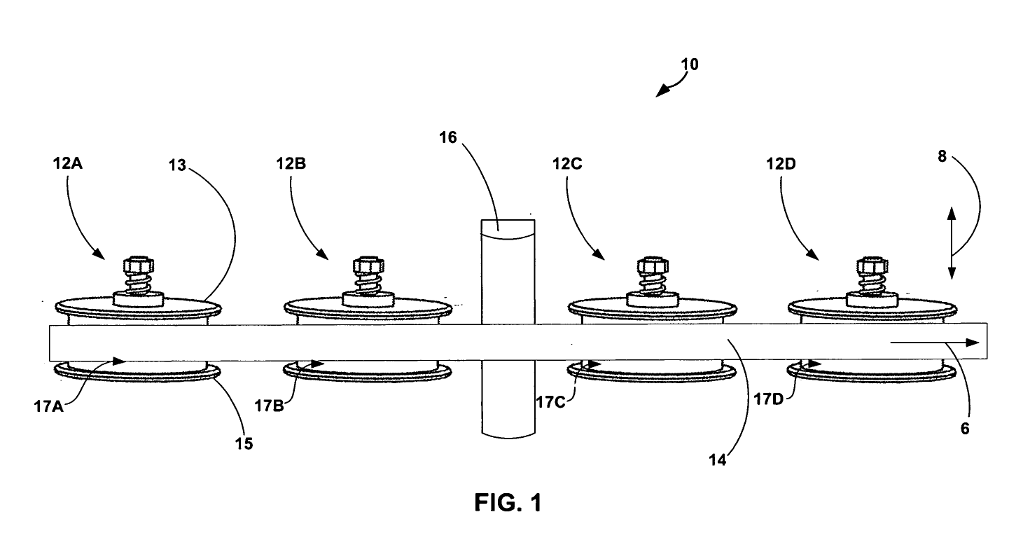

FIG. 1 is a perspective view of magnetic tape system 10 including an arrangement of tape guides 12A-12D (collectively guides 12), a magnetic head 16, and a magnetic tape 14 passing through guides 12 and over head 16. As shown in FIG. 1, magnetic tape 14 passes through guides 12 and over head 16 in the axial direction (represented by arrow 6) to facilitate the recording or readout of servo patterns or data.

Head 16 and the other heads described herein may comprise servo write heads designed to write servo information on magnetic tape, or servo read heads designed to read the servo information. Servo information refers to signals, patterns or other recorded markings on the data storage tape that are used to facilitate precise positioning of the read/write head relative to the data tracks on the data storage tape. In other embodiments, head 16 may comprise a head designed for data recording or data readout. In general, head 16 and the other heads described herein may comprise magnetoresistive (MR) heads, magneto-optic heads, servo heads, read heads, write heads, thin film heads, giant magnetoresistive (gMR) heads, or any other suitable heads.

A set of two or more of guides 12 may also be referred to herein as a tape guiding system. Guides 12 and arrangements of guides 12 may be used in servo writers, or various devices used during media fabrication. In other embodiments, guides 12 and arrangements of guides 12 may be used in tape drives, tape cartridges, or any other setting where tape guiding is desirable. Each of guides 12 may be substantially similar, although the invention is not necessarily limited in this respect. Guides 12 will be specifically described with reference to guide 12A. As shown, guide 12A includes an upper flange 13, a lower flange 15, and a tape path surface 17A between flanges 13 and 15. Magnetic tape 14 passes over tape path surface 17A and is guided by flanges 13 and 15.

Guides 12 may comprise generally cylindrical shaped centers which form the tape paths surface, and disk-shaped flanges adjacent to the cylindrical centers. However, other shapes could also be used. Guides 12 may comprise polished stainless steel or any other material.

As the data storage capacity of magnetic tape 14 and the number of data tracks on magnetic tape 14 increases, the track pitch (i.e., the distance between data tracks measured from track center to track center) typically decreases. The decreased track pitch may require a closer interface between head 16 and tape 14, which may require smoother surfaces on tape 14 and guides 12. For example, the average roughness (Ra) of tape 14 may be approximately less than five nanometers and, in some embodiments, approximately less than three nanometers measured as the average height of the bumps on a surface of tape 14. Furthermore, the average surface roughness (Ra) of each of the tape path surfaces 17A- 17D (collectively tape path surfaces 17) of guides 12A-12D, respectively, may be within the range of approximately 25 nanometers to approximately 155 nanometers and sometimes within the range of approximately 50 nanometers to approximately 105 nanometers.

As the surfaces of tape 14 and guides 12 become smoother, tape 14 may stick to guides 12, particularly when there is high friction between tape 14 and guides 12. For example, when the frictional force between tape 14 and guides 12 is stronger than the tensional force pulling tape 14 along guides 12 in axial direction 6, tape 14 may stick to guides 12 and cause damage to tape 14 (e.g., breaking and/or stretching). High friction between a tape guide 12 and magnetic tape 14 may occur, for example, when starting and/or stopping the motion of magnetic tape 14 across guides 12.

Damage to tape 14 may be prevented by rotating guides 12 when there is high friction between tape 14 and guides 12. Rotating guides 12 may help move tape 14 along guides 12 in axial direction 6. However, when the axial speed of tape 14 causes magnetic tape 14 to fly over tape path surfaces 17 of guides 12, rotation of guides 12 may not be necessary to prevent tape 14 from sticking to guides 12.

As tape 14 moves across guides 12, tape 14 drags air with it and creates an air barrier between guides 12 and magnetic tape 14. This air barrier lifts magnetic tape 14 off of tape path surfaces 17 of guides 12 and allows magnetic tape 14 to fly over tape path surfaces 17 of guides 12. The air barrier between guides 12 and tape 14 reduces the friction between tape path surfaces 17 of guides 12 and magnetic tape 14 and generally prevents tape 14 from sticking to guides 12.

By stopping the rotation of guides 12 while tape 14 is flying, some of the noise that may be transmitted to magnetic tape 14 when guides 12 are rotating can be eliminated. Since the rotating components of rotating guides store and release energy, a rotating guide can transmit bearing noise to tape 14 and cause lateral tape motion in the lateral direction (represented by arrows 8). Stationary guides that do not rotate generally cause fewer lateral tape motion problems than rotating guides. However, stationary guides often experience high friction that is capable of damaging magnetic tape when the magnetic tape is traveling along the guides at a low speed (e.g., upon startup and stopping of the magnetic tape). According to the invention, guides 12 may rotate when there is high friction between guides 12 and magnetic tape 14 and be rotationally static when magnetic tape 14 is flying over tape path surfaces 17 of guides 12. By rotating guides 12 when there is high friction between magnetic tape 14 and guides 12, damage to magnetic tape 14 may be prevented, and by not rotating guides 12 when tape 14 is flying, lateral tape motion may be reduced compared to guides that continue to rotate as tape 14 flies.

When tape 14 travels at an axial speed that causes magnetic tape 14 to fly over tape path surfaces 17 of guides 12, tape 14 drags air with it and creates an air barrier between guides 12 and magnetic tape 14 that substantially reduces the friction between guides 12 and tape 14. At axial speeds that are too low to cause magnetic tape 14 to fly over tape path surfaces 17, tape 14 may not drag enough air to create an air barrier that substantially reduces the friction between guides 12 and tape 14. When tape 14 travels at axial speeds that cause magnetic tape 14 to fly over tape path surfaces 17 of guides 12, guides 12 may be rotationally static, and when tape 14 travels at axial speeds insufficient to cause magnetic tape 14 to fly over tape path surfaces 17 of guides 12, guides 12 may rotate under a frictional force from magnetic tape 14.

When the axial speed of tape 14 causes magnetic tape 14 to fly over tape path surfaces 17 of guides 12, tape 14 may be flying high enough over tape path surfaces 17 of guides 12 to reduce the frictional force between guides 12 and tape 14 below the rotational force necessary to rotate guides 12, and when the axial speed of tape 14 is too low to cause magnetic tape 14 to fly over tape path surfaces 17, tape 14 may not be flying high enough over tape path surfaces 17 of guides 12 to reduce the frictional force between guides 12 and tape 14 below the rotational force necessary to rotate guides 12. In this manner, guides 12 may rotate when the frictional force between guides 12 and tape 14 is greater than the rotational force necessary to rotate guides 12, and guides 12 may be rotationally static when the frictional force between guides 12 and tape 12 is less than the rotational force necessary to rotate guides 12.

The rotational force required to rotate guides 12 may be controlled by one or more resistance mechanisms. One or more of guides 12 include a resistance mechanism that resists rotation of guides 12. When the frictional force between guides 12 and tape 12 is high, guides 12 may rotate, but when tape 14 flies over guides 12, the resistance mechanism may inhibit this rotation. That is to say, the resistance mechanism may inhibit rotation of guides 12 when an axial speed of magnetic tape 14 causes magnetic tape 14 to fly over flyable surfaces 17 of guides 12. However, guides 12 may rotate under a frictional force from magnetic tape 14 when the axial speed of magnetic tape 14 is insufficient to cause magnetic tape 14 to fly over flyable surfaces 17.

As described in greater detail below, the resistance mechanism of guides 12 may comprise a spring system, brush, lubricant viscosity, frictional clutch, and/or magnetically induced drag.

The point at which tape 14 lifts off of tape path surfaces 17 and flies over guides 12 may be dependent upon the surface roughness of tape path surfaces 17, the surface roughness of tape 14, the diameter of guide 12 and/or other variables. The minimum axial speed that causes magnetic tape 14 to fly over tape path surfaces 17 of guides 12 and/or the point at which the frictional force between guides 12 and tape 14 equals the rotational force necessary to rotate guides 12 may also be dependent upon any number of these variables.

In some embodiments, guides 12 may rotate for a specified number of revolutions upon startup of tape 14. Upon startup, a half inch wide tape (e.g., tape 14) generally lifts off of the tape path surfaces of one inch diameter guides (e.g., tape path surfaces 17 of guides 12) within two revolutions of the tape guides. Under typical tape system conditions (e.g., systems utilizing a tape and guides with typical surface properties and diameters), the axial speed of tape 14 may cause magnetic tape 14 to fly over tape path surface 17 in approximately one eighth of a revolution to approximately two revolutions of guides 12 upon startup of magnetic tape 14. For example, a typical tape system may include approximately one inch diameter guides 12 with tape path surfaces with average surface roughness values within the range of approximately 25 nanometers to approximately 155 nanometers. Magnetic tape 14 under approximately one Newton of tension may pass over tape path surfaces 17 of guides 12. Guides 12 may rotate until the axial speed of tape 14 reaches approximately one half of a meter per second. Tape 14 may reach this speed within approximately one eight of a revolution to approximately two revolutions of guides 12. Although startup of magnetic tape 14 is used as an example of when guides 12 rotate, rotation of guides 12 is not limited to the startup of tape 14 and may occur at other times when the frictional force between guides 12 and tape 14 is high (e.g., when magnetic tape 14 is stopping).

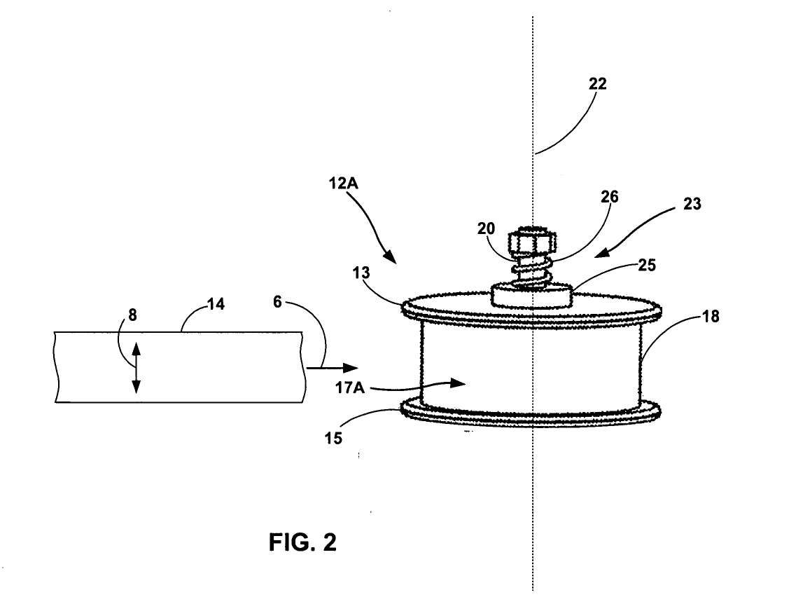

FIG. 2 is another perspective view of magnetic tape 14 to be passed over tape guide 12A. As shown, tape guide 12A defines a tape path surface 17A. Flanges 13 and 15 adjacent to tape path surface 17A define the boundaries of tape path surface 17A. Tape path surface 17A may comprise a portion of a generally cylindrical center (or core) 18 of tape guide 12A.

Guide 12A rotates on axle 20 about axis 22. More specifically, tape path surface 17A of guide 12A comprises a roller that rolls with magnetic tape 14 as magnetic tape 14 feeds over guide 12A. Spring system 23 including spring 26 and non-rotational element 25 functions as a resistance mechanism that resists rotation of guide 12A. Spring 26 holds non-rotational element 25 in contact with a surface of guide 12A, causing a frictional force between non-rotational element 25 and guide 12A that resists rotation of guide 12A. The resistance to rotation experienced by guide 12A is dependent upon the coefficient of friction between guide 12A and non-rotational element 25 and the normal force applied by spring 26. The load compressing spring 26 may be adjusted, which allows the amount of drag experienced by guide 12A to be adjusted. By modifying the amount of resistance to rotation (e.g., adjusting the load on the spring system), the point at which the guide 12A stops its rotation can be adjusted. In some embodiments, spring 26 may be compressed to provide enough resistance to prevent rotation of guide 12A when magnetic tape 14 is flying. In some embodiments, spring system 23 may provide a frictional force of approximately 0.05 Newton to approximately 0.5 Newton. In other embodiments, spring system 23 provides a frictional force of approximately 0.1 Newton.

Alternatively or additionally, other means of providing drag on guide 12A may also be used. For example, lubricant viscosity in the bearings, frictional clutch, and/or magnetically induced drag may be used to provide drag on guide 12A.

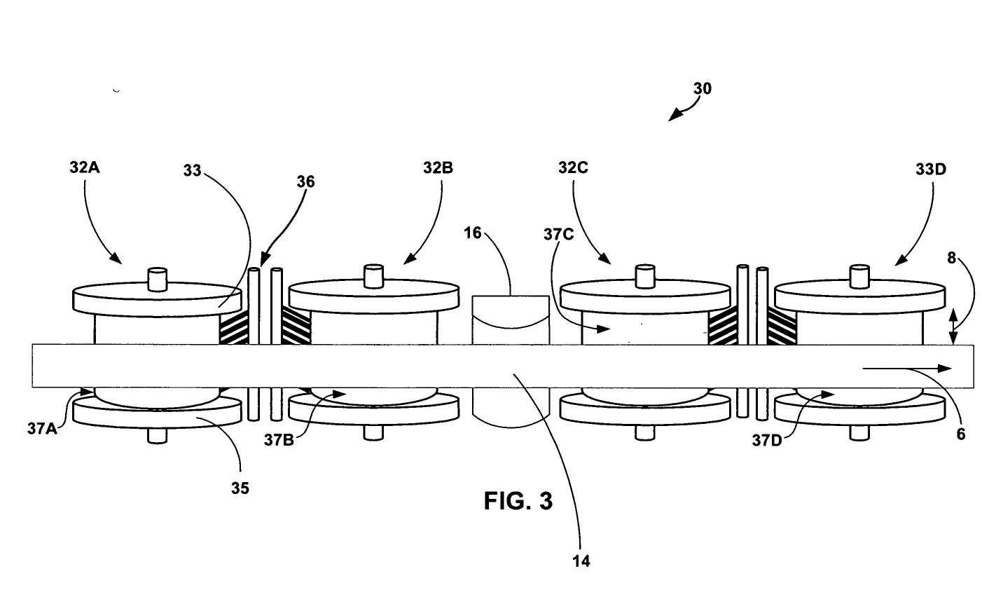

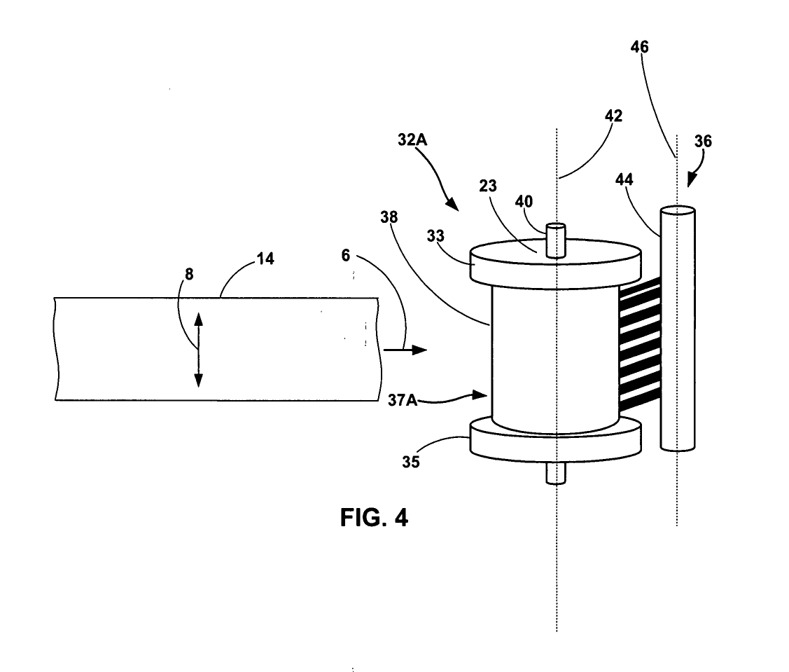

FIG. 3 is a perspective view depicting magnetic tape system 30 according to another embodiment of the invention, and FIG. 4 is another perspective view of magnetic tape 14 to be passed over tape guide 32A. The features and embodiments illustrated in FIGS. 1 and 2 may also be used in combination with the features described below with reference to FIGS. 3 and 4.

Magnetic tape system 30 includes an arrangement of tape guides 32A-32D (collectively guides 32), a magnetic head 16, and a magnetic tape 14 passing through guides 32 and over head 16. Again, a set of two or more of guides 32 may also be referred to herein as a tape guiding system. Head 16 may be positioned on either side of magnetic tape 14, e.g., the same side or a different side than guides 32. Each of guides 32 may be substantially similar, although the invention is not necessarily limited in this respect. Guides 32 will be specifically described with reference to guide 32A. As shown, guide 32A includes an upper flange 33, a lower flange 35, and a tape path surface 37 between flanges 33 and 35. Magnetic tape 14 passes over tape path surface 37 and is guided over tape path surface 37 between flanges 33 and 35. Again, guides 32 may comprise a generally cylindrical shaped core with disk shaped flanges 33 and 35 adjacent to the core, although other shapes could also be used. Guides 32 may comprise polished stainless steel or any other material.

Like guides 12 of FIG. 1, guides 32 may rotate when there is high friction between magnetic tape 14 and guides 12 and remain rotationally static when magnetic tape 14 is flying over tape path surfaces 37A-37D of guides 32A-32D, respectively. The rotational force required to rotate guides 32 may be controlled by one or more resistance mechanisms. One or more of guides 32 include a resistance mechanism that resists rotation of guides 32. With guides 32, the resistance to rotation may be at least partially applied using brushes. In this manner, one or more of guides 32 may include resistance mechanisms comprising brushes. For example, guide 32A includes brush 36, which may resist rotation of guide 32 in order to aid in inhibiting the rotation of guide 32A when magnetic tape 14 is flying. In addition to helping control the resistance to rotation felt by guide 32A, brush 36 may simultaneously help clean guide 32A of dirt and debris.

Flanges 33 and 35 of guide 32A have a tendency to pick up and store debris. As guide 32A rotates, the debris stuck to flanges 33 and 35 spins around and plucks magnetic tape 14, causing very high speed lateral tape motion in the lateral direction (represented by arrows 8). Debris on rotating guide 32A may also steer tape 14 into flanges 33 and 35, causing damage to the edges of tape 14. If flanges 33 and 35 are removed, the range of lateral tape motion is typically increased, which can cause issues when using modem high bandwidth actuators. Using brush 36 to clean guide 32 may help decrease problems caused by debris without increasing lateral tape motion.

FIG. 4 is another perspective view of magnetic tape 14 to be passed over tape guide 32A. As shown, tape guide 32A defines a tape path surface 37A. Flanges 33 and 35 adjacent to tape path surface 37A define the boundaries of tape path surface 37A. Tape path surface 37A may comprise a portion of a generally cylindrical center (or core) 38 of tape guide 32A.

Guide 32A rotates on axle 40 about axis 42. More specifically, tape path surface 37 of guide 32A comprises a roller that rolls with magnetic tape 14 as magnetic tape 14 feeds over guide 32A. Brush 36 may be rotated on axle 44 about axis 46. In this manner, brush 36 may be selectively placed into contact with cylindrical core 38 of guide 32A, which allows the amount of drag on guide 32A to be adjusted. By modifying the amount of resistance to rotation, the point at which the guide 32A stops its rotation can be adjusted.

Brush 36 may have an appearance similar to that of a toothbrush with bristles that contact tape path surface 37A of guide 32A. Additionally, brush 36 may be located on a back side of guide 32A such that brush 36 does not contact magnetic tape 14. Upon startup, guide 32A may rotate until the axial speed of tape 14 causes magnetic tape 14 to fly over tape path surface 27A (e.g., until the axial speed of tape 14 reaches approximately 0.5 meters per second). Brush 36 may be used to clean debris from guide 32A and add resistance to rotation of guide 32A to help inhibit the rotation of guide 32A once the axial speed of guide 32A causes magnetic tape 14 to fly over tape path surface 27A. In one embodiment, brush 36 applies enough friction to guide 32A to stop the rotation of guide 32A when tape 14 flies. In another embodiment, an additional resistance element is used in combination with brush 36. In some embodiments, brush 36 may be conductive to prevent static build-up on guide 32A.

Like guides 12, guides 32 may rotate when there is high friction between guides 32 and magnetic tape 14 and be rotationally static when magnetic tape 14 is flying over tape path surfaces 37 of guides 32. For example, when tape 14 travels at axial speeds that cause magnetic tape 14 to fly over tape path surfaces 27, guides 32 may be rotationally static, and when tape 14 travels at axial speeds insufficient to cause magnetic tape 14 to fly over tape path surfaces 27, guides 32 may rotate under a frictional force from the magnetic tape. In other words, guides 12 may rotate when the frictional force between guides 12 and tape 14 is greater than the rotational force necessary to rotate guides 12, and guides 12 may be rotationally static when the frictional force between guides 12 and tape 12 is less than the rotational force necessary to rotate guides 12.

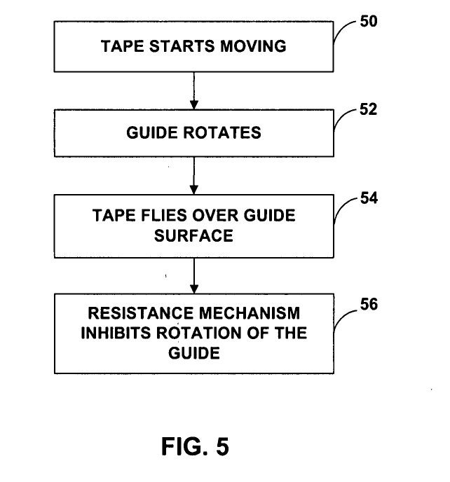

FIG. 5 is a flowchart illustrating one embodiment of a method in which resistance is added to the rotation of a flyable tape guide. While the process shown in FIG. 5 is described with respect to guide 12A of FIGS. 1 and 2, in other embodiments, the process may be used to selectively inhibit rotation of any suitable guide including a resistance mechanism in accordance with the invention. First, tape 14 begins moving over guide 12A (50), and the frictional force between tape path surface 17A of guide 12A and tape 14 rotates guide 12A as tape 14 passes over tape path surface 17A (52). The axial speed of tape 14 increases and eventually causes magnetic tape 14 to fly over tape path surfaces 17 of guides 12, which reduces the friction between tape 14 and tape path surface 17A of guide 12A (54). When tape 14 is flying, the frictional force between tape 14 and tape path surface 17A of guide 12A is less than the rotational force required to rotate guide 12A, so preloaded spring 26 inhibits the rotation of guide 12A (56). Although startup of magnetic tape 14 is used as an example of when guide 12A rotates, rotation of guide 12A is not limited to the startup of tape 14 and may occur at other times when the frictional force between guide 12A and tape 14 is greater than the rotational force required to rotate guide 12A.

Various embodiments of the invention have been described that may be used individually or in combination with other embodiments to provide for improvements in tape guiding. Although primarily described in the context of magnetic tape guiding, the invention may also be useful in guiding holographic tape, optical tape, magneto-optic tape, or other future generation data storage media.

The guides described above have been primarily described and illustrated as cylindrical guides having cylindrical cores with disk-shaped flanges. However, the same principles would apply to other non-cylindrical shaped guides, including elongated tape guides that define a complex tape path. In any case, the guides may be formed of any desirable material, e.g., polished stainless steel, another type of metal, hard plastic, or another suitable guide material.

The guides and arrangements of guides may be used in servo writers, or various devices used during media fabrication. In other embodiments, guides and arrangements of guides may be used in tape drives, tape cartridges, or any other setting where tape guiding is desirable. As examples, the guides and arrangements of guides described herein may be used to guide the magnetic tape during media fabrication, servo recording and servo verification, servo readout, data recording or data readout. Various embodiments of the invention have been described. These and other embodiments are within the scope of the following claims.

1. A magnetic tape system comprising:
a magnetic tape;
a magnetic head;
a set of guides arranged to guide the magnetic tape along a tape path over the magnetic head, the set of guides comprising:
a first rotatable guide positioned before the magnetic head along the tape path and including a first flyable tape path surface; and
a second rotatable guide positioned after the magnetic head along the tape path and including a second flyable tape path surface;
a first resistance mechanism that resists rotation of the first guide; and
a second resistance mechanism that resists rotation of the second guide.

2. The magnetic tape system of claim 1, wherein the first resistance mechanism inhibits rotation of the first guide when an axial speed of the magnetic tape causes the magnetic tape to fly over the first flyable surface, and wherein the first guide rotates under a frictional force from the magnetic tape when the axial speed of the magnetic tape is insufficient to cause the magnetic tape to fly over the first flyable surface.

3. The magnetic tape system of claim 2, wherein the frictional force between the first tape path surface and the magnetic tape is less than a rotational force required to rotate the first guide when the axial speed of the magnetic tape causes the magnetic tape to fly over the first flyable surface.

4. The magnetic tape system of claim 3, wherein the rotational force required to rotate the first guide is a function of a resistance to rotation applied by the resistance mechanism to the first guide.

5. The magnetic tape system of claim 2, wherein the axial speed of the magnetic tape causes the magnetic tape to fly over the first flyable surface in approximately one eighth of a revolution to approximately two revolutions of the first guide upon startup of the magnetic tape.

6. The magnetic tape system of claim 1, wherein the first resistance mechanism comprises a spring system with an adjustable load, wherein adjustment to the load on the spring system comprises adjustment to a resistance to rotation experienced by the first guide.

7. The magnetic tape system of claim 1, wherein the first resistance mechanism comprises a brush, wherein the brush contacts the first tape path surface to resist rotation of the first guide.

8. A set of guides arranged to guide a magnetic tape along a tape path over a magnetic head, the set of guides comprising:
a first rotatable guide positioned before the magnetic head along the tape path and including a first flyable tape path surface; and
a second rotatable guide positioned after the magnetic head along the tape path and including a second flyable tape path surface;
a first resistance mechanism that resists rotation of the first guide; and
a second resistance mechanism that resists rotation of the second guide.

9. The set of guides of claim 8, wherein the first resistance mechanism comprises at least one of a brush, a loaded spring, a friction clutch, a lubricant viscosity, or a magnetically induced drag.

10. The set of guides of claim 8, wherein each of the first and second tape path surfaces comprise an average guide surface roughness of approximately 25 nanometers to approximately 155 nanometers.

11. The set of guides of claim 10, wherein each of the first and second tape path surfaces comprise an average guide surface roughness of approximately 50 nanometers to approximately 105 nanometers.

12. The set of guides of claim 8, wherein a surface of the magnetic tape that contacts each of the first and second tape path surfaces comprises an average tape surface roughness of approximately less than five nanometers.

13. The set of guides of claim 12, wherein a surface of the magnetic tape that contacts each of the first and second tape path surfaces comprises an average tape surface roughness of approximately less than three nanometers.

14. The set of guides of claim 8, wherein at least one of the first and second tape path surfaces comprises polished stainless steel.

15. A rotatable tape guide assembly for data storage tape comprising:
a flyable tape path surface positioned along a tape path of a magnetic tape;
an upper flange adjacent to the tape path surface;
a lower flange adjacent to the tape path surface, and
a resistance mechanism that resists rotation of the guide.

16. The tape guide assembly of claim 15, wherein the resistance mechanism comprises a brush, and wherein the brush is positioned to brush the flyable tape path surface.

17. The tape guide assembly of claim 16, wherein the brush is conductive.

18. The tape guide assembly of claim 16, wherein the brush cleans the tape path surface.

19. The tape guide assembly of claim 15, wherein the resistance mechanism inhibits rotation of the guide when an axial speed of the magnetic tape causes the magnetic tape to fly over the tape path surface.

20. The tape guide assembly of claim 15, wherein the guide rotates under a frictional force from the magnetic tape when an axial speed of the magnetic tape is insufficient to cause the magnetic tape to fly over the tape path surface.
